(19) United States
(12) Patent Application Publication
(10) Pub. No.: US 2010/0033485 A1
(43) Pub. Date: Feb. 11, 2010

(54) METHOD FOR VISUALIZING MONITORING DATA

(75) Inventors: Ravi Kothari, New Delhi (IN); Tapan Kumar Nayak, New Delhi (IN); Anindya Neogi, New Delhi (IN)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/186,580

(22) Filed: Aug. 6, 2008

(51) Int. Cl. G06T 11/20

(52) U.S. Cl. 345/440

(57) ABSTRACT

Techniques for visualizing monitoring data are provided. The techniques include generating at least one context from the monitoring data based on a user-provided schema definition, mapping the data from a high dimensional space to a lower dimensional subspace using a topology preserving mapping, organizing the mapped data into a three-dimensional space to allow dynamic selection of a context resolution level across a hierarchy of the at least one context, using the mapped data to identify at least one trend in the data, wherein identifying the at least one trend comprises observing one or more changes over time in one or more activation patterns for each of the at least one context, and visualizing the at least one quantified trend in the data.

### FIELD OF THE INVENTION

The present invention generally relates to information technology, and, more particularly, to monitoring data.

### BACKGROUND OF THE INVENTION

In a monitoring system, events are generated when there is a state change (for example, the router's interface goes down) or an application of critical data crosses the predefined threshold (for example, central processing unit (CPU) utilization goes above 90 percent or a transaction response time increases). Besides events, data samples are also recorded in a normal state for offline analysis (for example, transaction response time, CPU utilization, etc.). A large volume of time-stamped event and data streams can flow from hundreds of sensors in a system.

As such, challenges exist in the extraction and visualization of the important characteristics of the data due to volume, large dimensionality of the data, and inherent relationships between various elements. The user can define semantics with the data based on the context in which it is collected, and it would be advantageous to visualize the data using this context information. The visualization should, advantageously, be multi-resolution so that one is able to get a high level understanding when the context is coarse and low level details when the context is fine-grained.

However, existing approaches do not enable multi-resolution visualization of monitoring data using context information. Some existing approaches, for example only visualize the historical data of selected parameters in graphical forms and the aggregation of plots that help a physician to view the parameters on the same dashboard. This is ineffective for system monitoring data with thousands of sources in a large enterprise system, as it will create thousands of plots, which is intractable. Other existing approaches do not include multi-resolution visualization in the context of system hierarchy.

### SUMMARY OF THE INVENTION

Principles of the present invention provide techniques for visualizing monitoring data. An exemplary method (which may be computer-implemented) for visualizing monitoring data, according to one aspect of the invention, can include steps of generating at least one context from the monitoring data based on a user-provided schema definition, mapping the data from a high dimensional space to a lower dimensional subspace using a topology preserving mapping, organizing the mapped data into a three-dimensional space to allow dynamic selection of a context resolution level across a hierarchy of the at least one context, using the mapped data to identify at least one trend in the data, wherein identifying the at least one trend comprises observing one or more changes over time in one or more activation patterns for each of the at least one context, and visualizing the at least one quantified trend in the data.

At least one embodiment of the invention can be implemented in the form of a computer product including a computer usable medium with computer usable program code for performing the method steps indicated. Furthermore, at least one embodiment of the invention can be implemented in the form of a system including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example of event data from a server, according to an embodiment of the present invention:

FIG. 2 is a diagram illustrating system architecture, according to an embodiment of the present invention;

FIG. 3 is a diagram illustrating the concept of three-dimensional (3-D) visualization, according to an embodiment of the present invention;

FIG. 4 is a diagram illustrating an exemplary three-dimensional (3-D) visualization, according to an embodiment of the present invention;

FIG. 5 is a flow diagram of the tool orchestration process, according to an embodiment of the present invention;

FIG. 6 is a diagram illustrating exemplary results, according to an embodiment of the present invention;

FIG. 7 is a flow diagram illustrating techniques for visualizing monitoring data, according to an embodiment of the present invention; and

FIG. 8 is a system diagram of an exemplary computer system on which at least one embodiment of the present invention can be implemented.

### DETAILED DESCRIPTION OF PREFERRED EMBODIMENTS

Principles of the present invention include visualization and analysis of system monitoring data using multi-resolution context information. As described herein, one or more embodiments of the invention use topology preserving mapping for monitoring data, as well as visualizing monitoring data in multiple resolutions using context information.

The techniques described herein analyze activation patterns over a period of time, quantify the trends based on a user-defined method and visualize these trends. Such techniques for visualization and analysis of monitoring data can, for example, be implemented using java. One or more embodiments of the invention enable a user to define context based on a schema definition, to include domain knowledge reflecting the dependencies among context elements, and to choose an appropriate context hierarchy, a resolution level, an interval length and a time span. Additionally, one or more embodiments of the invention map the corresponding data to a two-dimensional subspace using a topology preserving mapping. This enables the user to observe how the activation patterns vary along time at the selected resolution level.

The techniques described herein map input data collected from a large number of system resources into a two-dimensional subspace while preserving the topology of the input data. Moreover, the patterns and the numbers of maps can vary based on the resolution or level of system hierarchy selected by the user. This will help the user to monitor the health of the systems from different levels of hierarchy (for example, context hierarchy) in a large enterprise environment, as well as allow domain knowledge to be included by reflecting dependencies in the patterns to a weighted distance computation.

Further, one or more embodiments of the present invention include a framework for visualizing large number of time series data on a single map by reducing the dimensionality of the input data into a two-dimensional space while preserving the topology of the input data. Moreover, as noted herein, one can create maps at different levels of the context hierarchy.

The techniques described herein include advantageous tooling to enable deeper understanding of monitoring data, thus making system management more efficient. One or more embodiments of the invention can also be added to the portal that is used to visualize event data or raw monitoring data. One can also add the context information to the event and data streams.

Data samples can be collected using sensors from various data sources. One can assume, for example, that monitoring data is derived from a computer system, but generalizations are also possible. In a computer system, data is collected from servers, storage, network elements, databases, applications, etc. The semantics of data can be expressed in the form of string tags. For example, if CPU utilization data is collected from a server, the tags may include <metric=util/cpu>, <server-neptune>, <application=lapu>, <server owner=abc>, <app owner=xyz>, <service=prepaid billing>, <lob=billing>, and <geography=AP>.

These tags can be taken from a common information model (CIM) of the system or can be user-defined. A concatenation of the tags in a specific order provides the context of data. A coarser context can be obtained by selecting a prefix of the entire context. The order can be customized in the visualization tool to create the context structure from the tags.

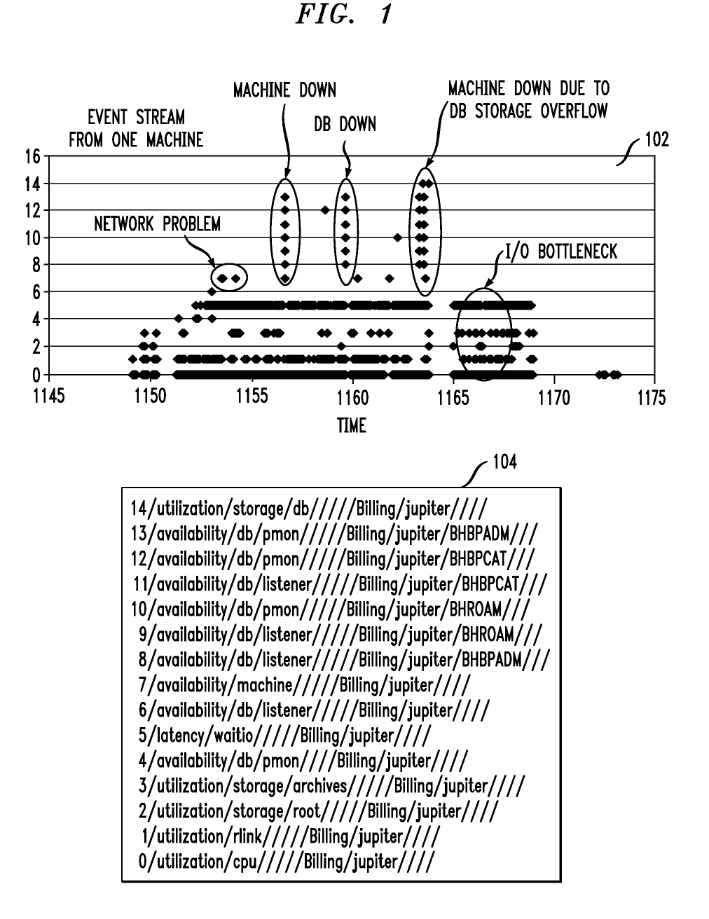

FIG. 1 is a diagram illustrating an example of event data from a server 102, according to an embodiment of the present invention. By way of illustration, FIG. 1 depicts 15 types of parameters monitored on a server, and event streams plotted on a timeline for a period of eight months. The context of each stream is fixed over 8 months and given on the side in element 104. Situations are represented by related events (highlighted using ellipses in FIG. 1) at a given context resolution. The context resolution can be made coarser by merging the event streams with common suffixes. Also, one can visualize related events and event groups by varying time and the context detail.

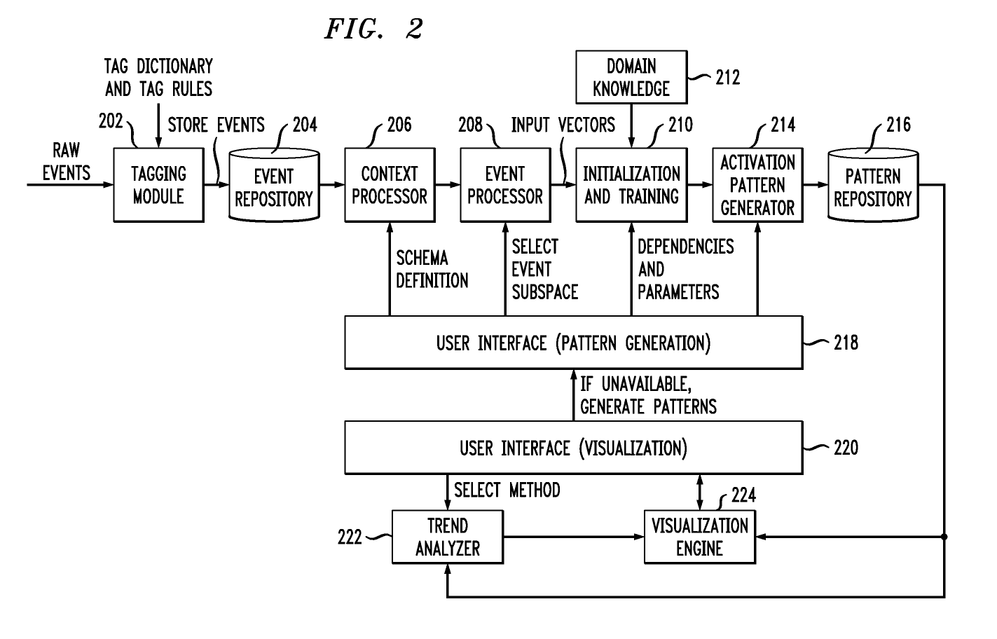

FIG. 2 is a diagram illustrating system architecture, according to an embodiment of the present invention. By way of illustration, FIG. 2 depicts the elements of a tagging module 202, an event repository 204, a context processor 206, an event processor 208, an initialization and training component 210, a domain knowledge component 212 and an activation pattern generator 214. FIG. 2 also depicts the elements of a pattern repository 216, a user interface (for example, for pattern generation) 218, a user interface (for example, for visualization) 220, a trend analyzer 222 and a visualization engine 224.

The context processor 206 generates a new set of contexts based on a user-defined schema and processes the context of each event. The event processor 208 accepts the inputs (preferred context component, time window, number of windows) and the context resolution level from the user interface, processes the events and generates vectors. The initialization and training component 210 accepts vectors from the event processor 208 and trains a neural network map. The activation pattern generator 214 generates activation patterns from the trained neural network.

The visualization engine 224 visualizes the patterns over different time periods across different context components at various resolutions of context hierarchy. Additionally, the user can interactively focus on different areas in the three dimensional (3-D) space, as well as dynamically switch the context component at the component axis, the time period and the context resolution level. In the process of visualization, if some requested patterns are not available in the pattern repository, the visualization engine 224 will send a message to generate the missing patterns. The trend analyzer 222 analyzes the activation patterns based on a user-defined method (for example, incremental difference), generates trends and is visualized by the visualization engine 224.

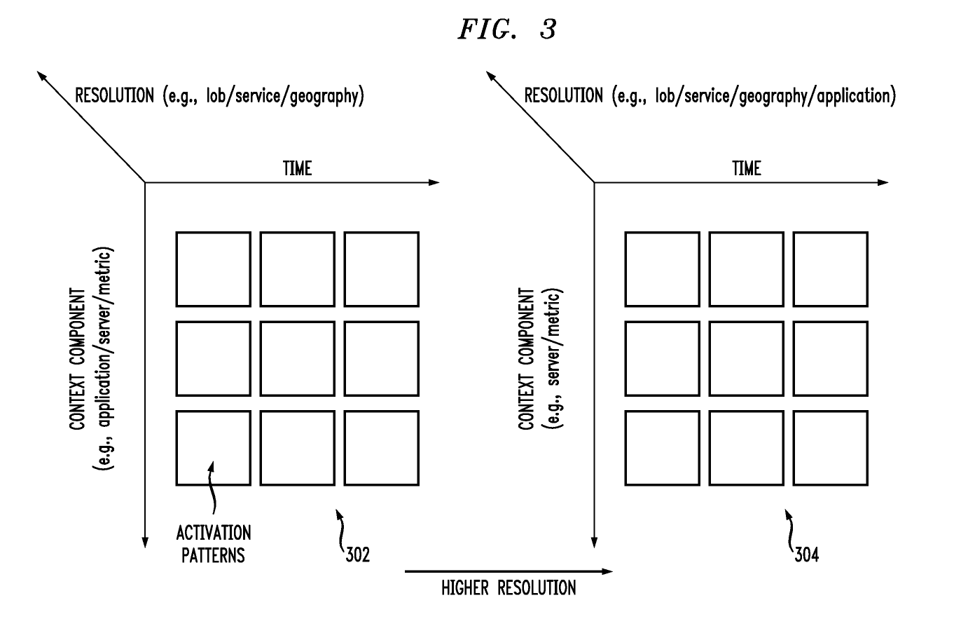

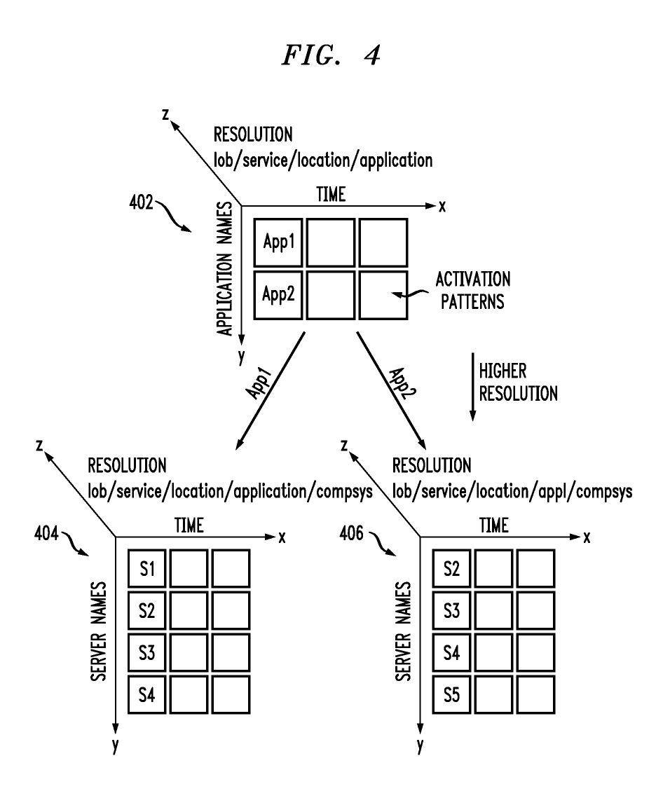

FIG. 3 is a diagram illustrating the concept of three-dimensional (3-D) visualization, according to an embodiment of the present invention. By way of illustration, FIG. 3 depicts event pattern graph 302 and event pattern graph 304. FIG. 4 is a diagram illustrating an exemplary three-dimensional (3-D) visualization, according to an embodiment of the present invention. By way of illustration, FIG. 4 depicts event pattern graph 402, sub-graph 404 and sub-graph 406. As described below, FIG. 3 and FIG. 4 depict visualization of event patterns.

For visualization of event patterns, a user can select a set of components from the system hierarchy (for example, a group of servers or a set of applications). This is equivalent to choosing one or more internal nodes of equal depth from the directed acyclic graph (DAG) of context hierarchy. One or more embodiments of the invention can include a tool that creates a sub-graph including all of the nodes which has a directed path from the selected nodes, and the events corresponding to the sink nodes will be used to generate the activation patterns. Note that the user-chosen nodes are the source nodes of the sub-graph and the sink nodes correspond to the contexts of the selected events.

Once the event sub-space is selected, the user specifies a time period for data collection. The tool will initialize and train a self-organizing feature map with the events of selected contexts collected over the specified time period. The resulting event pattern can be visualized, for example, on the dashboard. The user can generate multiple activation patterns from the same set of contexts by dividing the time interval into multiple time windows. The tool will visualize the patterns arranging chronologically along the time axis.

By way of example, one can assume a large enterprise system with a context hierarchy DAG of height 7 and the user is interested on two applications App1 and App2. Hence, the tool will create a 4-level sub-graph from the 7-level DAG of context hierarchy and isolate the events represented by the sink nodes. The tool will generate and visualize the event patterns related to these applications. The y-axis represents the user chosen context components, that is, the application names, App1 and App2 which are also the source nodes of the sub-graph. The z-axis (as seen, for example, in FIG. 3) represents the depth of the selected context components in the complete DAG and can be referred to as the “resolution” of visualization, as it helps to focus on the event patterns from various levels of system hierarchy. The user can observe a particular set of events closely by navigating to lower levels of the context hierarchy.

In the previous example, if the user wants to zoom on the event patterns for a particular server related to the applications App1 or App2, the tool will visualize the patterns in a higher resolution. In this way, one can navigate along the z-axis to observe the event patterns from different levels of the context hierarchy, and at each level, there is a two-dimensional grid of event patterns. Thus, the tool organizes the event patterns in a three-dimensional space and the user can dynamically switch to any resolution to focus on a particular set of events from a certain level of context hierarchy.

One or more embodiments of the invention include a self-organizing feature map (SOFM). A SOFM includes a neural network that learns to classify data without supervision. Neurons can be placed at the nodes of the lattice (for example, one or two dimension). Input can include multidimensional data represented by a vector such as x=[x₁, x₂, . . . xₘ]^{T}. Neurons become selectively tuned to input patterns by a competitive learning process. One neuron can be fired at one time, and a winning neuron can be represented as i(x)=arg min ∥x−wⱼ∥, j=1,2,3, . . . , 1.

A synaptic weight vector can be changed in relation to an input vector represented by wⱼ(n+1)=wⱼ(n)+η(n) h_{j,i}(x)(n)(x−wⱼ(n)). This can be applied to all neurons inside the neighborhood of neuron i. As such, an output can include a topology preserving map of input vectors on a one or two-dimensional lattice.

As noted above, a SOFM is an unsupervised classifier that provides a topology preserving mapping from the high dimensional space to map units. Map units, or neurons, usually form a two-dimensional lattice and, thus, the mapping is a mapping from high dimensional space onto a plane. The property of topology preserving indicates that the mapping preserves the relative distance between the points, and points that are near each other in the input space are mapped to nearby map units in the SOFM.

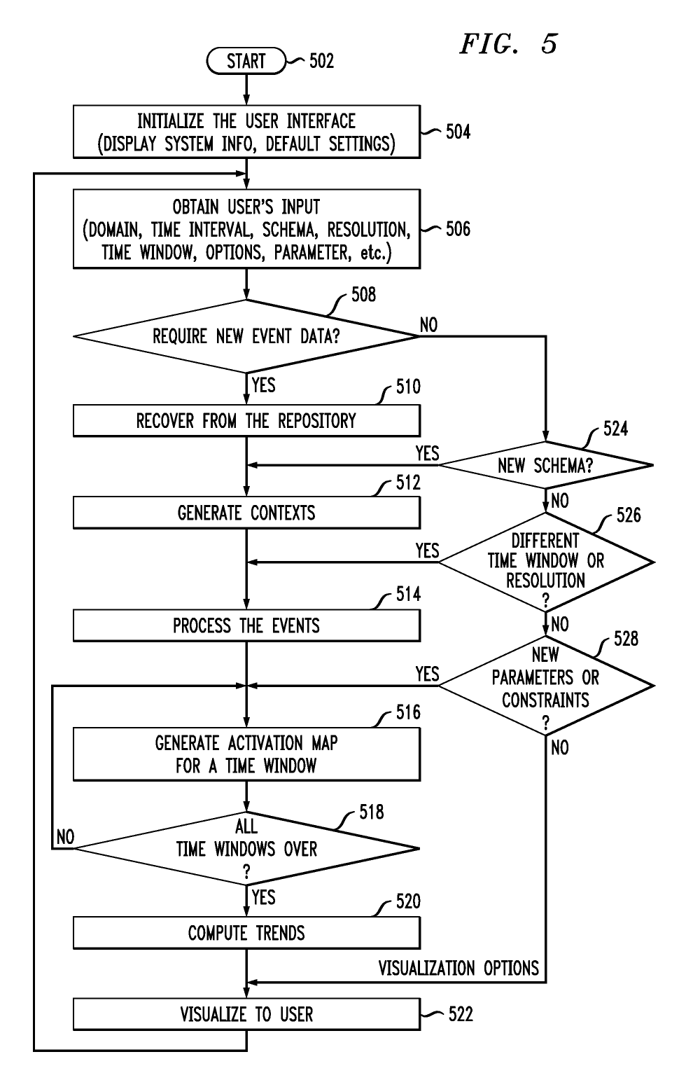

FIG. 5 is a flow diagram of the tool orchestration process, according to an embodiment of the present invention. Step 502 starts the process. Step 504 includes initializing the user interface (for example, display system info, default settings). Step 506 includes obtaining user's input (for example, domain, time interval, schema, resolution, time window, options, parameter, etc.). Step 508 includes asking whether new event data is required. If the answer to the question in step 508 is “yes,” then one can proceed to step 510 which includes recovering new event data from the repository. Step 512 includes generating contexts, step 514 includes processing the events and step 516 includes generating an activation map for a time window.

Step 518 includes asking whether all of the time windows are over. If the answer to the question in step 518 is “no,” then one returns to step 516. If the answer to the question in step 518 is yes,” then one continues to step 520, which includes computing trends. Also, step 522 includes visualizing the trends to the user.

If the answer to the question in step 508 is “no,” then one proceeds to step 524, which includes asking whether there is a new schema. If the answer to the question in step 524 is “yes,” then one can proceed to step 512. If the answer to the question in step 524 is “no,” then one continues to step 526, which includes asking whether there is a different time window or resolution. If the answer to the question in step 526 is “yes,” then one can proceed to step 514. If the answer to the question in step 526 is “no,” then one continues to step 528, which includes asking whether there are new parameters or constraints. If the answer to the question in step 528 is “yes,” then one can proceed to step 516. If the answer to the question in step 528 is “no,” then one continues to step 522. Additionally, from step 522, one can return back to step 506, as illustrated in FIG. 5.

One or more embodiments of the invention include a tool that can generate activation patterns for a large set parameters collected by a monitoring system and extract the relationship of various events over a period of time. The tool creates a three-dimensional structure of pattern space using the context hierarchy, and the user can interactively focus on different areas of the 3D pattern space. The user selects a domain or a subset of the system, a time interval, a resolution level from the context hierarchy, a time window, and a set of options for generating event patterns. The tool generates and visualizes the patterns for the corresponding event sub-space. The user can dynamically switch to a new event sub-space by modifying the selection through the user interface.

The tool automatically computes and visualizes the event patterns based on the current selections. The user has the option to define a new schema, assign different weights to different events, specify dependencies among events and control the parameters of the SOFM network. The tool automatically processes all the inputs and modifies the patterns as intended by the user. For every interaction in the user interface, an orchestrator interacts with various components of the tool in a specific sequence. An exemplary orchestration process is depicted in FIG. 5.

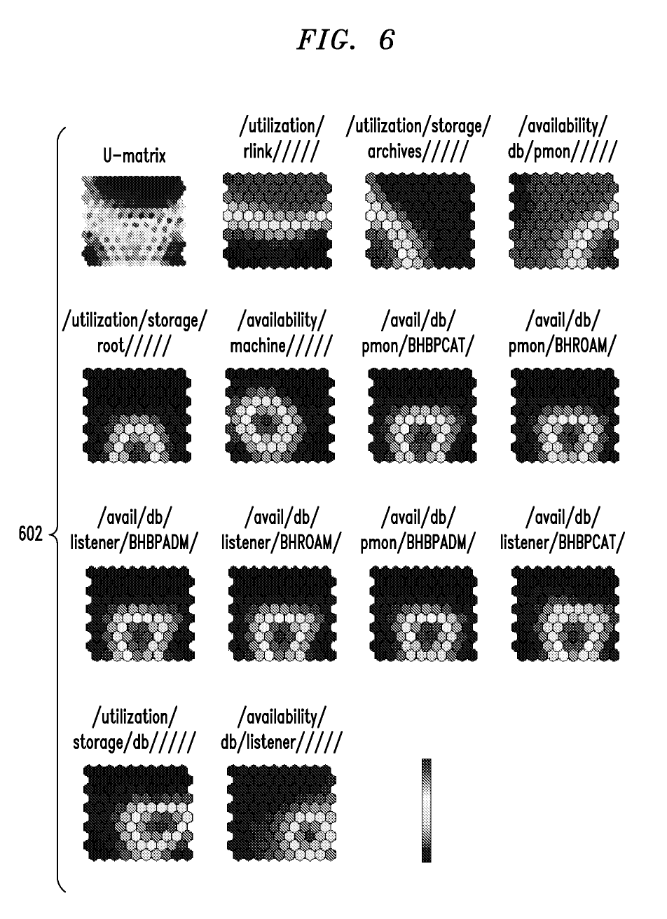

FIG. 6 is a diagram illustrating exemplary results 602, according to an embodiment of the present invention. By way of illustration, FIG. 6 depicts the unified matrix and the component planes considering 13 events monitored from the system. After training of the SOFM, the user can also observe the unified distance matrix or U-matrix and the component planes of the weight vectors. The U-matrix is a representation of the SOFM that visualizes the distances between the network neurons or units. It contains the distances from each unit center to all of its neighbors and the distances are presented with different colorings as shown in FIG. 6. The colors at the bottom of the color bar signify that the vectors are close to each other in the input space and these regions correspond to clusters. This representation can also be used to visualize the structure of the input space and to get an impression of otherwise invisible structures in a multi-dimensional data space.

The component planes of the SOFM are also shown in FIG. 6 where component 1-3 are mapped in the first row, 4-7 in the second row, and so on. Note that each of the 100 neurons has a 13-dimensional weight vector and each dimension represents a component. The visualization of component planes together shows the values of the map elements for different attributes. They show how the weight vectors vary over the space of the SOFM units. By relating component displays, one can interpret patterns as indications of structure and identify associations between attributes. Observe from FIG. 6 that the structure of the component planes 6-11 are close and it represents strong associations between these attributes. Thus we can conclude that the databases ‘BHBPCAT’, ‘BHROAM’ and ‘BHBPADM’ are placed in the same location and any disconnection causes failure to all the databases.

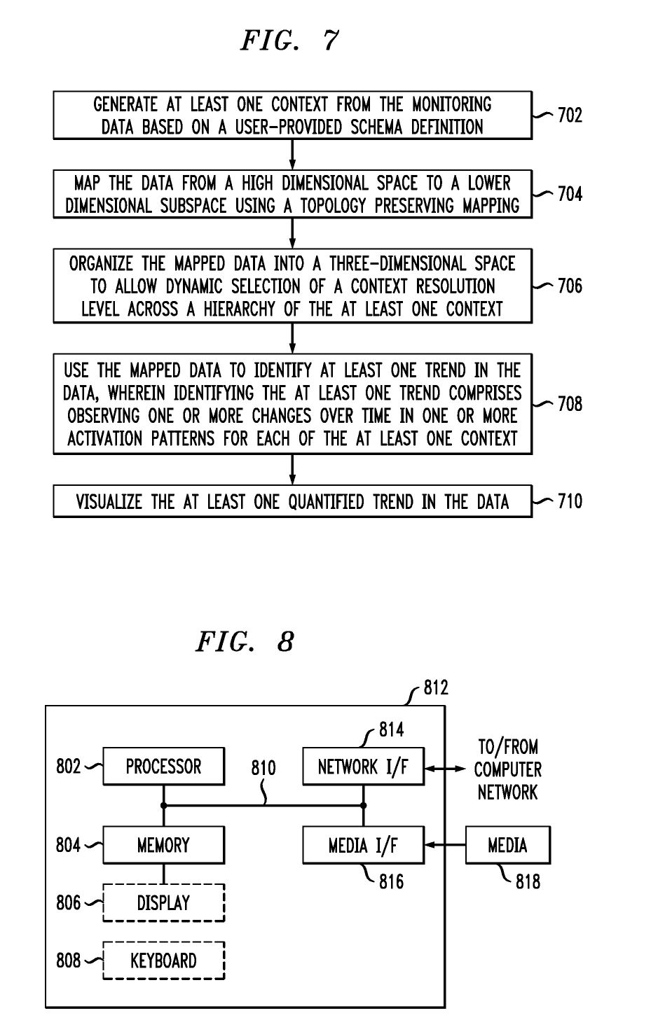

FIG. 7 is a flow diagram illustrating techniques (for example, interactive techniques) for visualizing monitoring data (for example, annotated monitoring data), according to an embodiment of the present invention. Step 702 includes generating at least one context from the monitoring data (for example, from annotations applied to the data expressed in at least one of numerical and categorical form) based on a user-provided schema definition. The context can include, for example, a concatenated annotation string depending on a source of the monitoring data. Also, one or more components of the context can be arranged in a hierarchical order according to a schema definition.

Step 704 includes mapping the data from a high dimensional space (for example, an n-dimensional hyperspace of the monitoring data collected from n sources) to a lower dimensional subspace (for example, a two-dimensional subspace) using a topology preserving mapping (for example, so as to allow for human visualization). Mapping the data can include, for example, allowing different context prefixes to be used to visualize the data at different resolutions. Mapping the data can also include incorporating or including domain knowledge by reflecting dependencies in patterns to a weighted distance computation.

Step 706 includes organizing the mapped data into a three-dimensional space to allow dynamic selection of a context resolution level across a hierarchy of the at least one context. Step 708 includes using the mapped data to identify at least one trend in the data, wherein identifying the at least one trend comprises observing one or more changes over time in one or more activation patterns for each of the at least one context. Step 710 includes visualizing the at least one quantified trend in the data.

The techniques depicted in FIG. 7 can also include, for example, quantifying the at least one trend in the data (for example, based on a user defined method). Additionally, one or more embodiments of the present invention can include selecting an appropriate context hierarchy, a resolution level, an interval length and a time span.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that the preferred implementation will make substantial use of software running on a general-purpose computer or workstation. With reference to FIG. 8, such an implementation might employ, for example, a processor 802, a memory 804, and an input and/or output interface formed, for example, by a display 806 and a keyboard 808. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 802, memory 804, and input and/or output interface such as display 806 and keyboard 808 can be interconnected, for example, via bus 810 as part of a data processing unit 812. Suitable interconnections, for example via bus 810, can also be provided to a network interface 814, such as a network card, which can be provided to interface with a computer network, and to a media interface 816, such as a diskette or CD-ROM drive, which can be provided to interface with media 818.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 818) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 804), magnetic tape, a removable computer diskette (for example, media 818), a random access memory (RAM), a read-only memory (ROM), a rigid magnetic disk and an optical disk. Current examples of optical disks include compact disk-read only memory (CD-ROM), compact disk-read and/or write (CD-RW) and DVD.

A data processing system suitable for storing and/or executing program code will include at least one processor 802 coupled directly or indirectly to memory elements 804 through a system bus 810. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 808, displays 806, pointing devices, and the like) can be coupled to the system either directly (such as via bus 810) or through intervening I/O controllers (omitted for clarity).

Network adapters such as network interface 814 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, enabling multi-resolution visualization of monitoring data using context information.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for visualizing monitoring data, comprising the steps of:
generating at least one context from the monitoring data based on a user-provided schema definition;
mapping the data from a high dimensional space to a lower dimensional subspace using a topology preserving mapping;
organizing the mapped data into a three-dimensional space to allow dynamic selection of a context resolution level across a hierarchy of the at least one context;
using the mapped data to identify at least one trend in the data, wherein identifying the at least one trend comprises observing one or more changes over time in one or more activation patterns for each of the at least one context; and
visualizing the at least one quantified trend in the data.

2. The method of claim 1, wherein the monitoring data comprises annotated monitoring data expressed in at least one of numerical and categorical form.

3. The method of claim 1, further comprising quantifying the at least one trend in the data.

4. The method of claim 1, wherein mapping the data comprises allowing one or more different context prefixes to be used to visualize the data at one or more different resolutions.

5. The method of claim 1, wherein mapping the data comprises including domain knowledge by reflecting one or more dependencies in one or more patterns to a weighted distance computation.

6. The method of claim 1, wherein the high dimensional space comprises an n-dimensional hyperspace of the monitoring data collected from n sources, and wherein the lower dimensional subspace comprises a two-dimensional subspace.

7. The method of claim 1, further comprising selecting an appropriate context hierarchy, a resolution level, an interval length and a time span.

8. The method of claim 1, wherein the at least one context comprises a concatenated annotation string depending on a source of the monitoring data.

9. The method of claim 1, wherein one or more components of the at least one context are arranged in a hierarchical order according to a schema definition.

10. A computer program product comprising a computer readable medium having computer readable program code for visualizing monitoring data, said computer program product including:
computer readable program code for generating at least one context from the monitoring data based on a user-provided schema definition;
computer readable program code for mapping the data from a high dimensional space to a lower dimensional subspace using a topology preserving mapping;
computer readable program code for organizing the mapped data into a three-dimensional space to allow dynamic selection of a context resolution level across a hierarchy of the at least one context;
computer readable program code for using the mapped data to identify at least one trend in the data, wherein identifying the at least one trend comprises observing one or more changes over time in one or more activation patterns for each of the at least one context; and
computer readable program code for visualizing the at least one quantified trend in the data.

11. The computer program product of claim 10, further comprising computer readable program code for quantifying the at least one trend in the data.

12. The computer program product of claim 10, wherein the computer readable code for mapping the data comprises:
computer readable program code for allowing one or more different context prefixes to be used to visualize the data at one or more different resolutions.

13. The computer program product of claim 10, wherein the computer readable code for mapping the data comprises:
computer readable program code for including domain knowledge by reflecting one or more dependencies in one or more patterns to a weighted distance computation.

14. The computer program product of claim 10, wherein the high dimensional space comprises an n-dimensional hyperspace of the monitoring data collected from n sources, and wherein the lower dimensional subspace comprises a two-dimensional subspace.

15. A system for visualizing monitoring data, comprising:
a memory; and
at least one processor coupled to said memory and operative to:
generate at least one context from the monitoring data based on a user-provided schema definition:
map the data from a high dimensional space to a lower dimensional subspace using a topology preserving mapping;
organize the mapped data into a three-dimensional space to allow dynamic selection of a context resolution level across a hierarchy of the at least one context;
use the mapped data to identify at least one trend in the data, wherein identifying the at least one trend comprises observing one or more changes over time in one or more activation patterns for each of the at least one context; and
visualize the at least one quantified trend in the data.

16. The system of claim 15, wherein the at least one processor coupled to said memory is further operative to quantify the at least one trend in the data.

17. The system of claim 15, wherein in mapping the data, the at least one processor coupled to said memory is further operative to allow one or more different context prefixes to be used to visualize the data at one or more different resolutions.

18. The system of claim 15, wherein in mapping the data, the at least one processor coupled to said memory is further operative to include domain knowledge by reflecting one or more dependencies in one or more patterns to a weighted distance computation.

19. The system of claim 15, wherein the high dimensional space comprises an n-dimensional hyperspace of the monitoring data collected from n sources, and wherein the lower dimensional subspace comprises a two-dimensional subspace.

20. The system of claim 15, wherein the at least one processor coupled to said memory is further operative to select an appropriate context hierarchy, a resolution level, an interval length and a time span.
